(19) United States
(12) Patent Application Publication
(10) Pub. No.: US 2023/0052119 A1
(43) Pub. Date: Feb. 16, 2023

(54) DUST SHEET FOR REDUCING BRAKE NOISE AND BRAKE SYSTEM COMPRISING A DUST SHEET

(71) Applicant: MANDO CORPORATION, Pyeongtaek-si (KR)

(72) Inventor: Hatem SHAHIN, Pfaffenhofen (DE)

(73) Assignee: MANDO CORPORATION, Pyeongtaek-si (KR)

(21) Appl. No.: 17/866,959

(22) Filed: Jul. 18, 2022

(30) Foreign Application Priority Data
Aug. 10, 2021 (DE) 10 2021 208 733.7

(51) Int. Cl. F16D 65/02; F16D 55/00

(52) U.S. Cl. CPC F16D 65/02; F16D 55/00; F16D 2065/13; F16D 2055/0037

(57) ABSTRACT

The invention relates to a dust sheet for a vehicle brake, configured for reducing brake noise, wherein the dust sheet comprises sub-centimetre damping structures for attenuating airborne sound, the damping structures being formed by a plurality of holes and/or a plurality of embossings. The invention also relates to a brake system for a vehicle, in particular a disk brake system, comprising such a dust sheet.

The application is in the field of mechanical engineering, in particular automotive engineering. It relates to a dust sheet for a vehicle brake which is configured for reducing brake noise and to a brake system comprising such a dust sheet.

Reduction of brake noise has long been the subject of research and development, and known approaches for reducing noise include for instance improved brake pad design, wherein novel materials are employed, or chamfers are provided on the brake pads.

Ever more expensive solutions have however not produced fully satisfactory results and it is thus an object of the present invention to present a solution for further reducing brake noise in an inexpensive and effective manner.

This is achieved by a dust sheet according to independent claim 1 and by a brake system according to claim 22.

Accordingly, a dust sheet according to the invention is configured for reducing brake noise. The dust sheet comprises sub-centimetre damping structures for attenuating airborne sound, the damping structures being formed by a plurality of holes and/or a plurality of embossings. A brake system according to the invention comprises such a dust sheet.

Dust sheets are known brake components, which are supposed to shield further brake parts from dust, small stones or other foreign bodies. The inventor realized that known solutions for reducing brake noise focus on reducing vibrations or structure-borne sound. In a complete turn away from these approaches, the inventor realized that a reduction of airborne sound represents an effective alternative or addition to known approaches, which has been neglected.

The sub-centimetre damping structures allow for efficient damping of airborne sound, since their extensions are on an order of magnitude that is relevant for attenuating audible sounds. The “sub-centimetre damping structures” are to be understood in such a way, that they have at least one spatial dimension or at least one defining feature that is on the order of less than a centimetre. This means that for instance an areal extension (i.e. length and/or a width) and/or a distance between them may be less than a centimetre, in order to allow efficient damping. In possible embodiments, the damping structures are arranged in regular or irregular patterns. For instance, holes or embossings may be arranged in grids, where a distance between the structures and/or an areal extension of the structures themselves may constitute the relevant quantity that is less than one centimetre. In another example, embossings describe a wave-pattern, to which wave-pattern a “wavelength” (distance between embossings) may be assigned, which may represent the relevant quantity that is less than one centimetre.

In a possible embodiment of the dust sheet, in at least one spatial direction on a surface of the dust sheet, an areal extension of the holes and/or an areal extension of the embossings is at most 3 mm, or at most 2 mm, or at most 1 mm. For instance, a diameter or a cross section of the holes or the embossings, or a width of the holes or the embossings may be at most 3 mm or at most 2 mm or at most 1 mm.

In possible embodiments, a diameter or a cross section of the holes or embossings is at least 0.3 mm or at least 0.4 mm or at least 0.5 mm and/or at most 1.5 mm or at most 1.25 mm or at most 1 mm.

For example, elliptic (and in particular circular) holes or embossings may be envisioned, but also holes or embossings having a different shape, such as a polygonal shape (in particular rectangular or quadratic). A maximum cross section, along their longest extension may be chosen to be at most 1.5 mm or at most 1.25 mm or at most 1 mm. Maximum extensions of this type may advantageously be chosen for holes, so that the stability and function of the dust sheet are not affected.

A distance between nearest-neighbouring holes and/or a distance between nearest neighbouring embossings may be at least 5 mm or at least 8 mm and/or at most 20 mm or at most 15 mm. In an embodiment, the distance between nearest-neighbouring holes and/or nearest-neighbouring embossings is 10 mm.

The dust sheet may comprise a total of at least 50 holes or embossings or at least 100 holes or embossings or at least 150 holes or embossings or at least 180 holes or embossings. Additionally or alternatively it may comprise a total of at most 400 holes or embossings or at most 300 holes or embossings or at most 250 holes or embossings or at most 220 holes or embossings.

In the dust sheet the embossings may comprise at least one raised embossing and/or at least one depressed embossing.

It is possible to provide the plurality of holes or embossings with an elongated shape, i.e., they may be carried out as slits, grooves, elongated protrusions.

Elongated shapes may particularly advantageously be provided for embossings. The elongated embossings or holes may have a straight course and/or a curved course and/or a zigzag course.

Particularly when the holes or embossings are carried out with an elongated shape, it may be envisioned to provide them with a width of at most 2 mm or at most 1.5 mm or at most 1 mm. Additionally or alternatively, they may have a length of at least 0.5 cm or at least 1 cm or at least 2 cm and/or at most 10 cm or 8 cm or 5 cm.

Particularly when the holes or embossings are carried out with an elongated shape, the dust sheet may include at least 5 holes or embossings or at least 10 holes or embossings or at least 15 holes or embossings. Additionally or alternatively, the dust sheet may comprise at most 50 holes or embossings or at most 40 holes or embossings.

As can be seen, in typical embodiments with elongated shapes, a smaller number of holes or embossings may be envisioned than in cases where the shape of the holes or embossing is more restricted area-wise (for instance when having elliptic or polygonal holes or embossings).

The embossings may have a depth or a height of at least 0.1 mm or at least 0.2 mm or at least 0.5 mm and/or at most 2 mm or at most 1 mm.

The dust sheet may be made of a temperature resistant plastic or of a temperature resistant matrix material, in particular a textile-like matrix material.

The dust sheet may be devoid of metal. It is also possible to have a dust sheet that comprises metal. In these cases, a cover layer may advantageously be provided. Cover layers are described in detail further below.

A thickness of the dust sheet may be at least 1 mm and/or at most 4 mm or at most 3 mm or at most 2 mm.

If the dust sheet comprises embossings, the embossings may be provided on the surface of the dust sheet that is configured to face a surface of a brake disk. Additionally or alternatively, the embossings may be provided on the surface of the dust sheet that is configured to face away from the brake disk. The embossings may be provided (for instance punched or drawn) in such a manner, that a depressed embossing is generated on one side, and a corresponding raised embossing is generated on the opposite side.

The dust sheet may comprise a first layer, which has the plurality of holes and/or the plurality of embossings described above, wherein the dust sheet additionally comprises at least one additional layer, at least in a section of the dust sheet. The additional layer may be arranged plane-parallel to said first layer.

Providing a dust sheet with one or more additional layers, as described herein, may advantageously contribute to noise reduction. In particular, additional one or more layers may, by themselves, effect noise reduction, even when no sub-centimetre damping-structures in the form of holes or embossments are provided. It is disclosed herein, a dust sheet for reducing brake noise by attenuating airborne sound, having a first layer and an additional layer, wherein the first layer (or the additional layer, for that matter) does not necessarily, but only optionally comprise the aforementioned sub-centimetre structures. This constitutes a separate invention which solves the technical problem stated above. The Applicant also reserves the right to claim this dust sheet with two layers, optionally in combination with all of the further features disclosed herein, for instance in a subsequent divisional application.

The at least one additional layer may be arranged on the side of the brake disk, with regard to the first layer, and/or it may be arranged on the side away from the brake disk, with regard to the first layer.

The at least one additional layer may comprise at least one cover layer. The at least one cover layer may be carried out as a temperature-resistant cover layer. The at least one cover layer may in particular be made from a material that is flexible and/or soft and/or designed as a textile-like fabric or web. A cover layer of this type is typically thinner than the first layer which has the plurality of holes and/or embossings. The thickness of the at least one cover layer may for instance be at least 0.2 mm and/or at most 0.5 mm. The at least one cover layer may be arranged on a side that is configured to face a brake disk and/or on a side that is configured to face away from the brake disk.

Additionally or alternatively, the at least one additional layer may comprise an equivalent layer to the first layer. The equivalent layer may be equivalent to the first layer in that it is made of the same material as the first layer and/or in that it has the same thickness as the first layer. This may be in contrast to a cover layer, which is typically thinner than the first layer and/or made from a different material.

The additional layer, in particular the equivalent layer, may be arranged at a distance of at least 0.2 mm and/or at most 0.5 mm from the first layer.

The equivalent layer may comprise sub-centimetre damping structures for attenuating airborne sound, the damping structures of the equivalent layer being formed by a further plurality of holes and/or a further plurality of embossings. In these embodiments, the two layers, first layer and equivalent layer, may be identical or equivalent to each other with regard to the damping structures, and all the properties of the damping structures of the first layer (as shown herein) may be applied to the damping structures of the additional equivalent layer.

The dust sheet may in particular comprise one, two, or three additional layers. It is in particular envisioned to have both a cover layer and an equivalent layer, for instance a cover layer on one side of the first layer, and a cover layer on the other side of the first layer. It is also envisioned to have two cover layers, one on each side of the first layer. It is also envisioned to have an equivalent layer, and two cover layers, the cover layers for instance being provided on an outside of each of the first layer and the equivalent layer.

In the dust sheet described herein, the damping structures may be arranged at least in a section of the dust sheet that is configured to face a portion of the brake disk that is opposite to a point of engagement of the brake disk with a brake pad of the brake system. In particular, it is not necessary—though not excluded and also envisioned herein—to extend the dust sheet as a cover over the brake pad and/or caliper. Instead, good results for noise attenuation may advantageously be achieved, if the brake disk is covered opposite from the brake pad.

The damping structures may be provided in a section of the dust sheet that is configured to extend over at least 10% of an area of the brake disk or at least 20% or at least 30%.

It will be appreciated by the person of skill, that the aforementioned aspects regarding arrangement with respect to the brake disk may be seen from the dust sheet itself.

The brake system for a vehicle according to the invention is in particular a disk brake system. The brake system comprises a dust sheet according to the disclosure of the application.

In the brake system, a distance between the dust sheet and a brake disk of the brake system may be at least 0.5 mm or at least 0.6 mm and/or at most 2 mm or at most 1.5 mm or at most 1 mm. This distance may be provided at least in the area which has the damping structures. Correspondingly, the dust sheet may be configured to have this distance to the brake disk, when mounted on the brake.

The invention shall now be explained in an exemplary manner, with reference to the appended figures.

Therein:

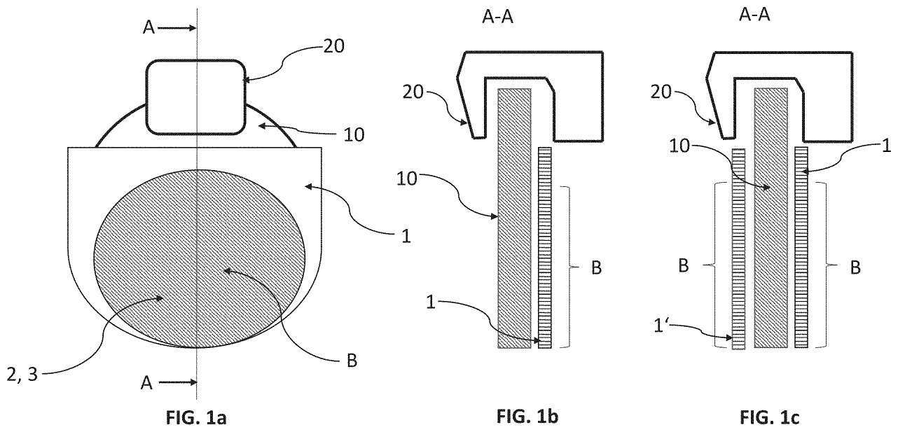

FIGS. 1a-c schematically show different views of a vehicle brake comprising a dust sheet,

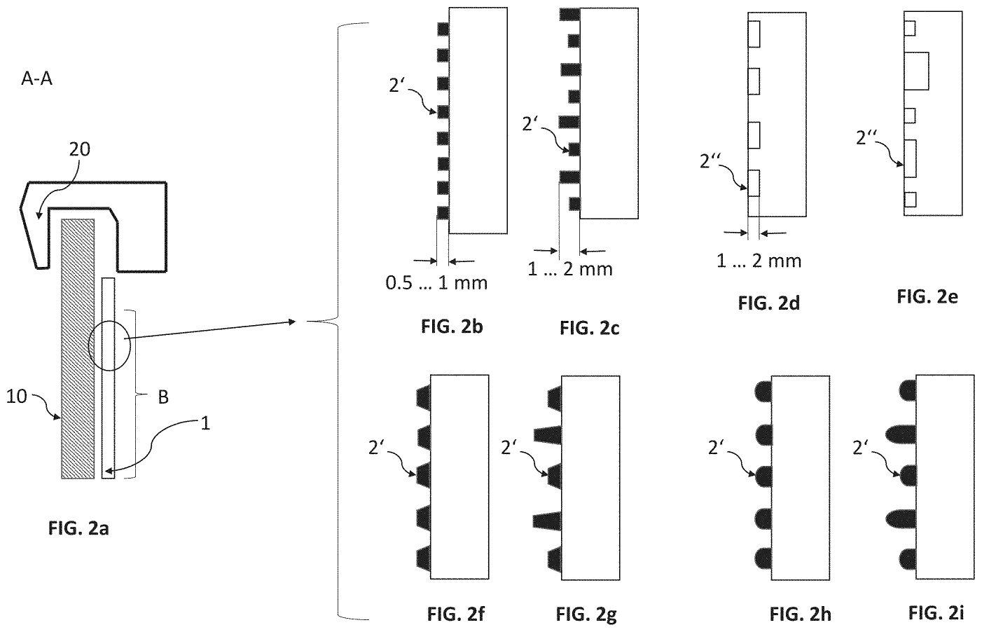

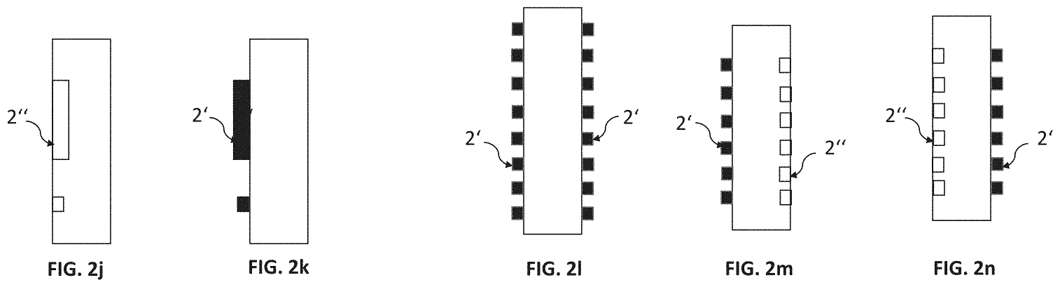

FIGS. 2a-n illustrate embodiments of the dust sheet with embossings,

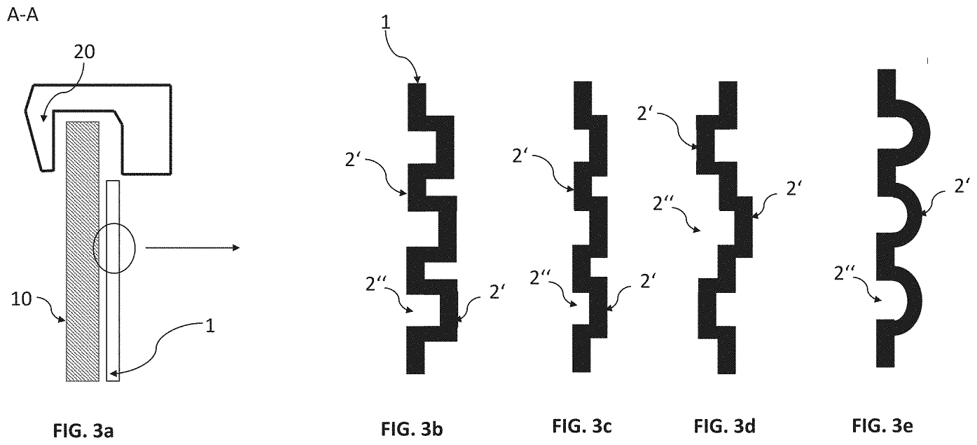

FIGS. 3a-e illustrate further embodiments of the dust sheet with embossings,

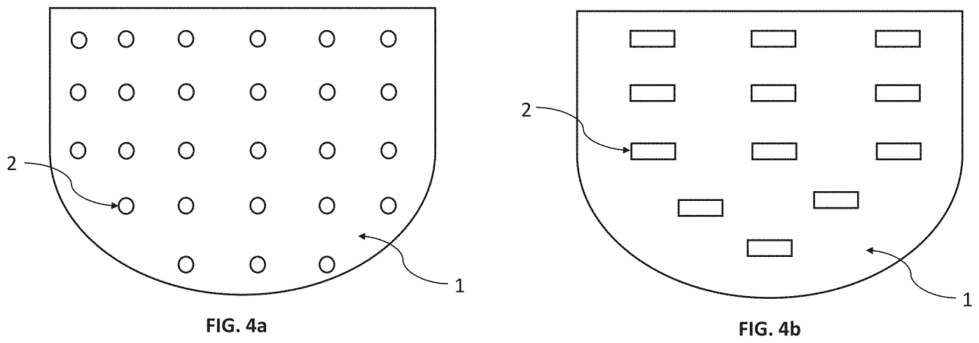

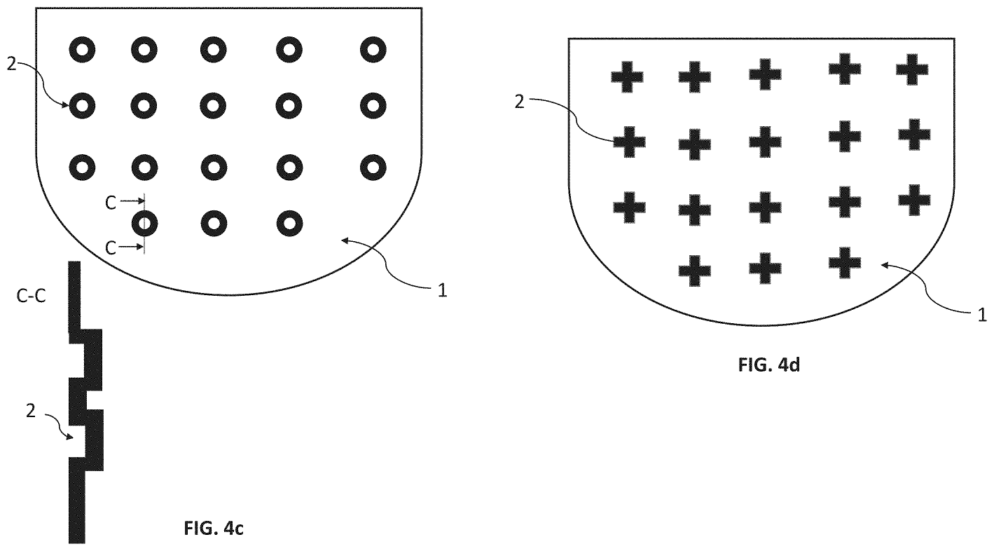

FIGS. 4a-d illustrate further embodiments of the dust sheet with embossings, the embossings arranged in a grid-like pattern,

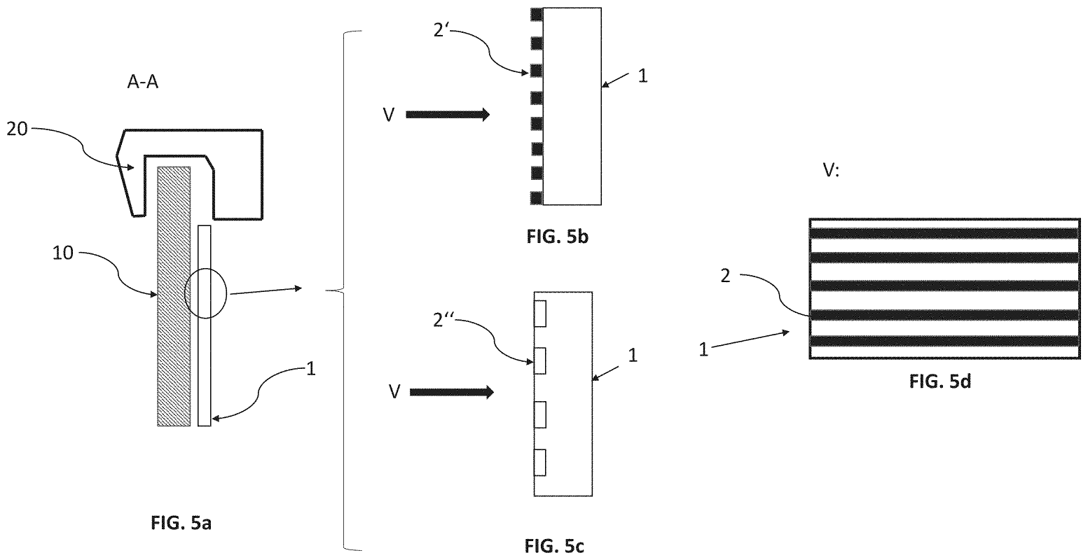

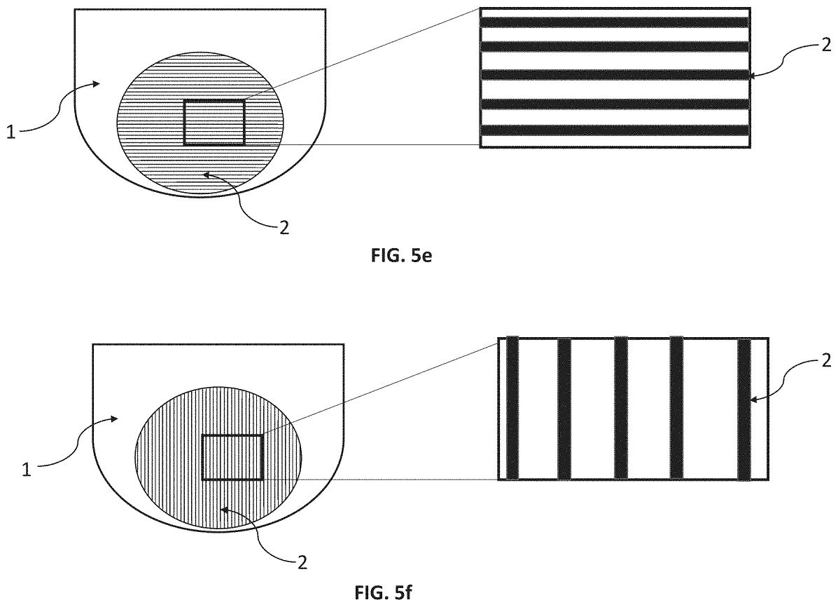

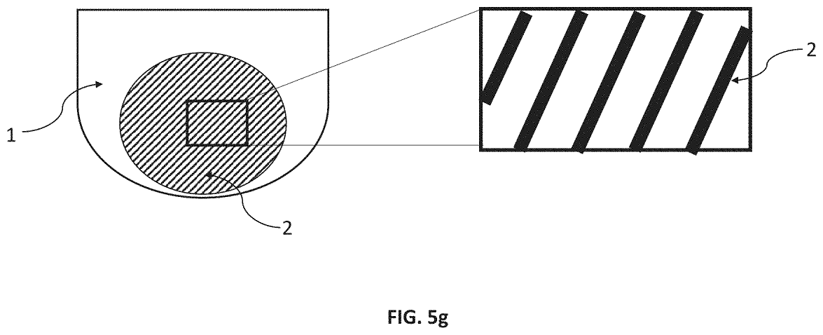

FIGS. 5a-g illustrate further embodiments of the dust sheet with embossings, carried out as elongated embossings,

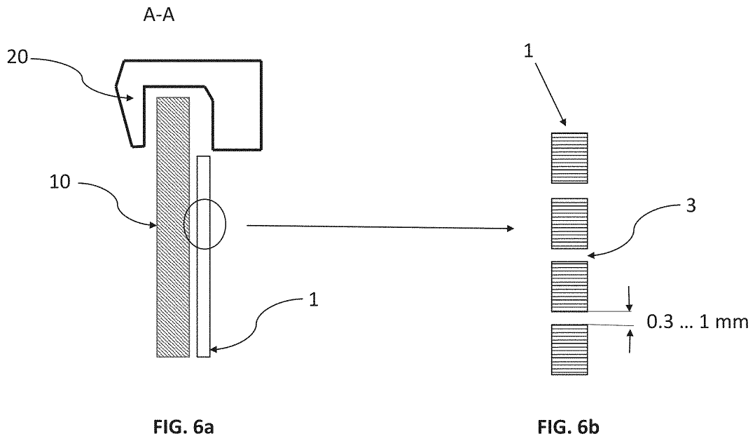

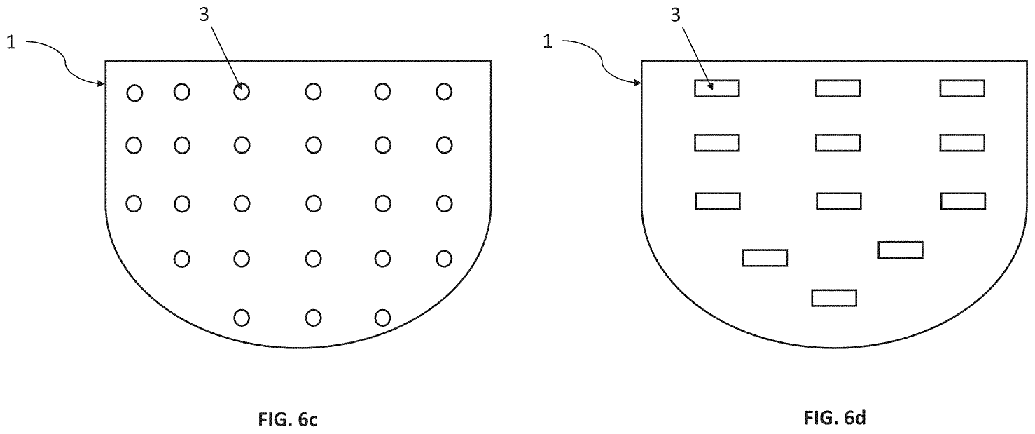

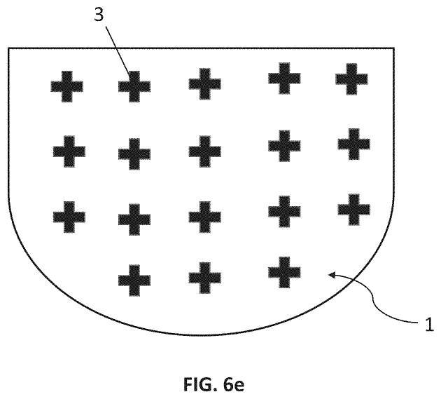

FIGS. 6a-e illustrate embodiments of the dust sheet with holes,

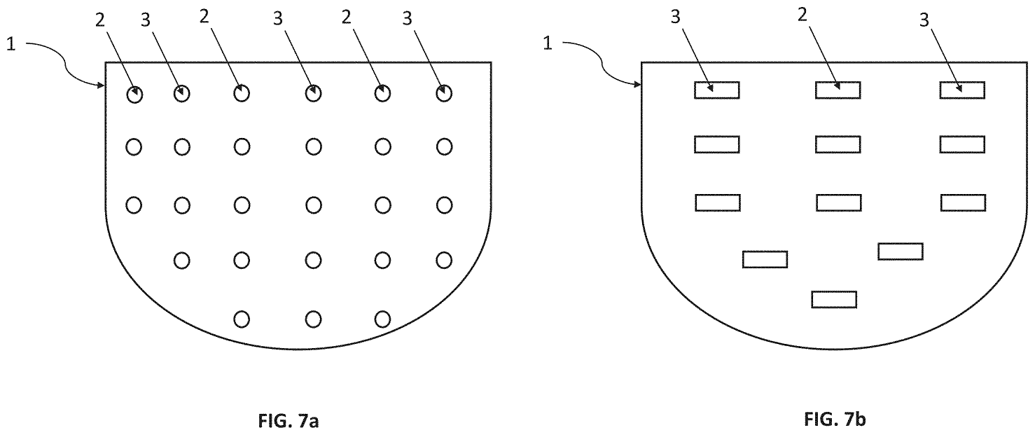

FIGS. 7a-b show embodiments having holes and embossings,

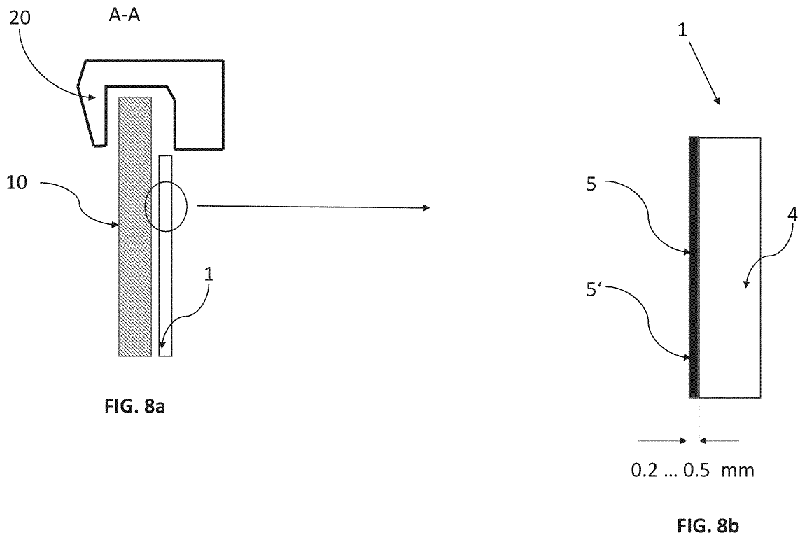

FIGS. 8a-b illustrate a dust sheet with a cover layer, and

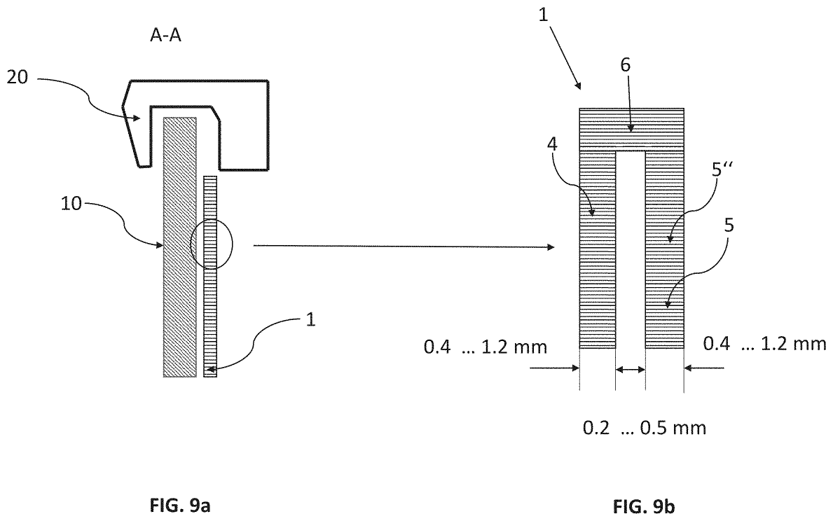

FIGS. 9a-b illustrate a dust sheet with a first layer and an equivalent second layer.

FIG. 1a shows a side view onto an inner side of a disk brake system. All figures are for illustrative purposes and are not to scale. The brake system comprises a brake disk 10, a caliper 20, and a dust sheet 1. The dust sheet 1 is configured for reducing brake noise, wherein the dust sheet 1 comprises sub-centimetre damping structures for attenuating airborne sound. The damping structures are formed by a plurality of holes 3 and/or a plurality of embossings 2, as will be explained further in the context of FIGS. 2-6.

The dust sheet 1 is arranged to cover a portion of the brake disk 10, extending over more than half of an area of the brake disk 10.

The damping structures are arranged at least in a section B of the dust sheet, which faces a portion of the brake disk 10 that is opposite to a point of engagement of the brake disk 10 with a brake pad of the brake system, which brake pad is held by the caliper 20. The section B, which has the damping structures, extends over at least 30% of an area of the brake disk.

FIGS. 1b and 1c show cuts through the brake system, along the line B-B from FIG. 1a. In the case of FIG. 1b a single dust sheet 1 according to this invention is arranged on an inner side of the brake disk 10. In the case of FIG. 1c, two dust sheets 1, 1′ according to the invention are provided, one on each side of the brake disk 10. The section B, which has the holes 3 or embossings 2 is indicated for each of the dust sheets 1, 1′ in FIGS. 1b and 1c. It is also possible, to provide a dust sheet 1 according to the invention only on an outer side of the brake disk 10.

Relating to FIGS. 1a-c, in each case, a distance between the dust sheet 1 and the brake disk 10 is between 0.6 mm and 1 mm. A thickness of the dust sheet 1 is between 1 mm and 4 mm.

The dust sheet 1 is made of a temperature resistant plastic or of a temperature resistant matrix material, such as a textile-like matrix material. The dust sheet is preferably devoid of metal.

FIG. 2a shows once again the cut A-A. A circle marks a portion of the dust sheet, which lies within the section B, having the damping structures. FIGS. 2b-2o show the circled portion in an enlarged manner, so that the damping structures can be seen. FIGS. 2b-2o relate to embodiments having embossings 2. The embossings 2 may be carried out as raised embossings 2′ and/or as depressed embossings 2″, as explained further below. FIGS. 2b-2o illustrate the height and shape of the embossings, and their width as it can be seen in a view corresponding to the cut A-A. No further assumptions are made with regard to their areal extension into the plane of the paper, which is not visible in the cut view. Areal extension along the two dimensions defined by the plane of the dust sheet 1 will be discussed in the context of FIGS. 4 and 5.

FIGS. 2b-2k focus on embodiments where the embossings 2 are provided only on a side of the dust sheet 1 which faces the brake disk 10. Additionally, embossings 2 are provided on the side facing away from the brake disk 10, in the case of FIGS. 2l-2n.

FIG. 2b shows an embodiment having a multitude of raised embossings 2′ with identical height, width and shape. They are in each case between 0.5 and 1 mm high, as indicated in the figure.

FIG. 2c shows raised embossings of different, alternating height, with a maximum height of between 1 mm and 2 mm.

FIG. 2d shows a multitude of identical depressed embossings 2″, each with a depth of between 1 mm and 2 mm.

The dimensions (heights/depths) of FIGS. 2b-2d may advantageously be applied to the embossings shown in the following figures.

FIG. 2e shows several depressed embossings 2″, which differ from each other in depth, and in width.

FIG. 2f shows a plurality of raised embossings 2′ with sloped side-walls.

FIG. 2g shows a plurality of raised embossings 2′ with sloped side-walls, with alternating height.

FIG. 2h shows a plurality of raised embossings 2′ with rounded edges.

FIG. 2i shows a plurality of raised embossings 2′ with rounded edges, with alternating height.

FIG. 2j, shows a plurality of depressed embossings 2″, whose widths differ from one another.

FIG. 2j, shows a plurality of raised embossings 2′, whose widths differ from one another.

FIG. 2l shows an embodiment having raised embossings 2′ on both sides. The embossings 2′ on either side may be carried out as shown in either of FIGS. 2b-2k.

FIG. 2m shows an embodiment having raised embossings 2′ facing the brake disk 10, and depressed embossings 2′ facing away from the brake disk 10. The embossings 2′, 2″ on either side may be carried out as shown in either of FIGS. 2b-2k.

FIG. 2n shows an embodiment having raised embossings 2′ facing away from the brake disk 10, and depressed embossings 2″ facing the brake disk 10. The embossings 2′, 2″ on either side may be carried out as shown in either of FIGS. 2b-2k.

FIGS. 3a-3e show embossings 2 that are carried out in such a manner that material is displaced to affect both sides of the dust sheet 1, i.e. a depression on one side goes along with a protrusion on the opposing side. The embossings of this type may be punched or drawn. FIG. 3b-3d show embodiments having step-like depressed and raised embossings 2′, 2″ in alternating fashion, on both sides of the disk. FIG. 3d has a double-step pattern. FIG. 3e shows an embodiment wherein rounded depressions 2″ are formed on the side of the brake disk 10, displacing material away from the brake disk 10 and resulting in rounded protrusions 2′ on the side that faces away from the brake disk.

FIGS. 4a-4d show views onto an inner surface of the dust sheet 1, which inner surface faces the brake disk 10. The figures illustrate areal extensions of the embossings 2, i.e. extension of the embossings over the inner surface of the dust sheet 1. Therein, FIGS. 4a-4b relate to shapes that are restricted in both areal dimensions. These embodiments comprise between 180 and 220 embossings 2, which are arranged in a grid-like pattern. For illustrative purposes, only a much smaller number of embossings is shown in the Figures. The grid-like patterns are shown as rectangular grids. Other grid-types and even randomly distributed arrangements are also possible.

No assumptions are made with regard to the remaining properties of the embossings 2 which are not visible in FIGS. 4a-4d. The embossings 2 may be carried out as raised embossings 2′, depressed embossings 2″, or as a combination thereof. They may have the properties shown in either of FIGS. 2-3 and all of their subfigures. They may also be combined with holes 3, in particular they may form a common pattern with holes 3, which holes 3 will be explained in the context of FIG. 6.

In the cases of FIGS. 4a-4d, areal extension of the embossings (2) is restricted in both areal dimensions to at most 1 mm. I.e., a diameter or a cross section of the embossings 2 is at most 1 mm. The diameter or the cross section may be as small as for instance 0.5 mm or 0.3 mm.

Referring once again to each of FIGS. 4a-4d, a distance between nearest-neighbouring embossings 2 is less than 15 mm and may be as small as for instance 5 mm.

FIG. 4a shows elliptic embossings 2, namely circular embossings 2.

FIG. 4b shows polygonal embossings 2, namely rectangular embossings 2.

FIG. 4c shows circular embossings 2 which are carried out as rings, as can be seen in the cut C-C pertaining to FIG. 4c.

FIG. 4d shows an embodiment having polygonal embossings 2 with a cross-like shape.

FIGS. 5a-5g relate to embodiments with embossings 2 that are carried out as elongated embossings. They may be designed as depressed 2″ and/or raised embossings 2′ (as schematically shown in FIGS. 5b and 5c). They may have any of the shapes indicated for instance in FIGS. 2 and 3.

The elongated embossings of FIGS. 5a-5g are area-wise restricted in one dimension only. They can have a width of at most 3 mm, or at most 2 mm, or at most 1 mm. They may have a distance of 10 mm or less from one another.

Their length may be at least 2 cm and for instance up to 10 cm.

The embossings 2 with an elongated shape can have a straight course and/or a curved course and/or a zig-zag course. FIG. 5d shows a straight course, which runs horizontally across the dust sheet 1.

The dust sheet with elongated embossings 2 may include at least 10 embossing 2 or at least 15 embossings 2, and for instance up to 50 of these embossings 2

FIG. 5e illustrates elongated embossings 2 extending horizontally across the dust sheet 1.

FIG. 5f illustrates elongated embossings 2 extending vertically across the dust sheet 1.

FIG. 5g illustrates elongated embossings 2 extending diagonally across the dust sheet 1.

FIGS. 6a and 6b illustrate a dust sheet 1 with holes 3, i.e. through-holes. The holes are distributed in the dust sheet 1 and they may be arranged in the same patterns that were shown for the embossings 2 above. A diameter or cross-section of the holes is less than 1 mm and for instance down to 0.3 mm, as shown in the Figure.

FIGS. 6c-6e illustrate different shapes for the holes 3. The holes 3 of FIG. 6c are circular, the holes 3 of FIG. 6d are rectangular, and the holes of FIG. 6e are cross-shaped. Like before, in the case of the embossings 2, the holes are arranged in grid-patterns. A distance between nearest-neighbouring holes 3 is less than 15 mm and may be as small as for instance 5 mm.

The dust sheet 1 has at least 180 holes 3 and may has between 180 and 220 holes 3.

FIGS. 7a-b show embodiments wherein the dust sheet 1 has both holes 3 and embossings 2. In these examples, the embossings 3 and holes 2 are arranged in a grid-like pattern, in alternating fashion.

FIGS. 8 and 9 relate to embodiments, wherein the dust sheet 1 has an additional layer 5.

FIGS. 8a-b show a dust sheet having a first layer 4, which first layer 4 may have the holes 3 and/or embossings 2 as explained herein.

The dust sheet furthermore comprises the additional layer 5, which is arranged plane-parallel to the first layer 4 and carried out as a temperature resistant cover-layer 5′, having a thickness of between 0.2 and 0.5 mm. It is made from a flexible, soft material, in particular a textile-like fabric or web.

The cover layer 5′ is arranged on a side that is configured to face the brake disk 10. Additionally or alternatively, a cover layer 5′ of this type may be arranged on the opposite side of the dust sheet 1.

FIGS. 9a-b show a further embodiment which includes a first layer 4, which may have the holes 3 and/or embossings 2 as explained herein, and an additional layer 5. The additional layer 5 is arranged plane-parallel to the first layer 4 and it is carried out as an equivalent layer 5″ to the first layer 4. The equivalent layer 5″ is made of the same material as the first layer 4 and it has the same thickness as the first layer 4.

The equivalent layer 5″ is arranged at a distance of between 0.2 mm and 0.5 mm from the first layer 4. The first layer 4 and the equivalent layer 5″ are connected by a web 6. The equivalent layer 5″ also comprises sub-centimetre damping structures for attenuating airborne sound, the damping structures of the equivalent layer 5″ being formed by a further plurality of holes and/or a further plurality of embossings. The further holes and/or embossings may be carried out like the holes 3 and embossings 2 of the first layer 4, which are explained herein.

### LIST OF REFERENCE NUMERALS

1, 1′ Dust Sheet
2 Embossing
2′ Embossing (raised)
2″ Embossing (depressed)
3 Hole
4 First Layer
Additional Layer
5′ Cover Layer
5″ Equivalent Layer
6 Web
Brake Disk
20 Caliper

1. A dust sheet for a vehicle brake, configured for reducing brake noise, wherein the dust sheet comprises sub-centimetre damping structures for attenuating airborne sound, the damping structures being formed by a plurality of holes and/or a plurality of embossings.

2. The dust sheet according to claim 1, wherein, in at least one spatial direction on a surface of the dust sheet, an areal extension of the holes and/or an areal extension of the embossings is at most 3 mm, or at most 2 mm, or at most 1 mm.

3. The dust sheet according to claim 1, wherein a distance between nearest-neighbouring holes and/or a distance between nearest neighbouring embossings is at least 5 mm or at least 8 mm and/or at most 20 mm or at most 15 mm, in particular the distance between nearest-neighbouring holes and/or nearest-neighbouring embossings being 10 mm.

4. The dust sheet according to claim 1, wherein a diameter or a cross section of the holes or embossings is at least 0.3 mm or at least 0.4 mm or at least 0.5 mm and/or at most 1.5 mm or at most 1.25 mm or at most 1 mm.

5. The dust sheet according to claim 1, comprising a total of at least 50 holes or embossings or at least 100 holes or embossings or at least 150 holes or embossings or at least 180 holes or embossings and/or at most 400 holes or embossings or at most 300 holes or embossings or at most 250 holes or embossings or at most 220 holes or embossings.

6. The dust sheet according to claim 1, wherein the embossings comprise at least one raised embossing and/or at least one depressed embossing.

7. The dust sheet according to claim 1, wherein the plurality of holes or embossings have an elongated shape, in particular with a straight course and/or a curved course and/or a zigzag course.

8. The dust sheet according to claim 7, wherein the embossings or holes have a width of at most 2 mm or at most 1.5 mm or at most 1 mm and/or a length of at least 0.5 cm or at least 1 cm or at least 2 cm and/or at most 10 cm or 8 cm or 5 cm.

9. The dust sheet according to claim 7, wherein the dust sheet includes at least 5 holes or embossings or at least 10 holes or embossings or at least 15 holes or embossings and/or at most 50 holes or embossings or at most 40 holes or embossings.

10. The dust sheet according to claim 1, wherein the embossings have a depth or a height of at least 0.1 mm or at least 0.2 mm or at least 0.5 mm and/or at most 2 mm or at most 1 mm.

11. The dust sheet according to claim 1, wherein the dust sheet is made of a temperature resistant plastic or of a temperature resistant matrix material, in particular a textile-like matrix material.

12. The dust sheet according to claim 1, wherein the dust sheet is devoid of metal.

13. The dust sheet according to claim 1, wherein a thickness of the dust sheet is at least 1 mm and/or at most 4 mm or at most 3 mm or at most 2 mm.

14. The dust sheet according to claim 1, wherein the dust sheet comprises a first layer, comprising the plurality of holes and/or the plurality of embossings, and at least one additional layer which is arranged plane-parallel to the first layer.

15. The dust sheet according to claim 14, wherein at least one additional layer comprises at least one cover layer, preferably a temperature-resistant cover layer, in particular made from a material that is flexible and/or soft and/or designed as a textile-like fabric or web.

16. The dust sheet according to claim 14, wherein the at least one cover layer is arranged on a side that is configured to face a brake disk and/or on a side that is configured to face away from the brake disk.

17. The dust sheet according to claim 14, wherein the at least one additional layer comprises an equivalent layer to the first layer, the equivalent layer being made of the same material as the first layer and/or having the same thickness as the first layer.

18. The dust sheet according to claim 17, wherein the equivalent layer is arranged at a distance of at least 0.2 mm and/or at most 0.5 mm from the first layer.

19. The dust sheet according to claim 17, wherein the equivalent layer comprises sub-centimetre damping structures for attenuating airborne sound, the damping structures of the equivalent layer being formed by a further plurality of holes and/or a further plurality of embossings.

20. The dust sheet according to claim 1, wherein the damping structures are arranged at least in a section of the dust sheet that is configured to face a portion of the brake disk that is opposite to a point of engagement of the brake disk with a brake pad of the brake system.

21. The dust sheet according to claim 1, wherein the damping structures are provided in a section of the dust sheet that is configured to extend over at least 10% of an area of the brake disk or at least 20% or at least 30%.

22. A brake system for a vehicle, in particular a disk brake system, comprising a dust sheet according to claim 1.

23. A brake system according to claim 22, wherein a distance between the dust sheet and a brake disk is at least 0.5 mm or at least 0.6 mm and/or at most 2 mm or at most 1.5 mm or at most 1 mm.
